(19) United States
(12) Patent Application Publication
(10) Pub. No.: US 2024/0182344 A1
(43) Pub. Date: Jun. 6, 2024

(54) CUSTOMIZABLE MULTISTAGE FILTER ASSEMBLY WITH REUSABLE SELF-CONTAINED FILTER HOUSING ENABLED WITH DATA REPORTING

(71) Applicant: David Matthew Benson, Washington, DC (US)

(72) Inventor: David Matthew Benson, Washington, DC (US)

(21) Appl. No.: 17/833,819

(22) Filed: Jun. 6, 2022

(51) Int. Cl. C02F 9/20; B01D 35/02; B01D 36/02; C02F 1/00; C02F 1/68; C02F 103/08; F25D 23/12

(52) U.S. Cl. CPC C02F 9/20; B01D 35/02; B01D 36/02; C02F 1/002; C02F 1/003; C02F 1/685; F25D 23/126; B01D 2201/305; B01D 2201/4015; B01D 2201/4023; B01D 2201/4038; B01D 2201/4084; B01D 2201/4092; B01D 2201/56; C02F 2103/08; C02F 2201/006; C02F 2209/008; C02F 2303/04; C02F 2307/02; C02F 2307/04; C02F 2307/12; F25D 2323/121

(57) ABSTRACT

The reusable multi-staged filtration device presented is a highly efficient and sustainable solution, utilizing recycled materials and advanced technologies for effective contaminant filtration, including desalination. Customizable filter options and settings optimize performance for specific environmental conditions and user preferences, enhancing contaminant removal capabilities. The eco-friendly design incorporates self-cleaning functionality, reducing waste and manual maintenance, thereby improving overall efficiency. This Smart Technology device leverages Artificial Intelligence and Machine Learning integration to enable enhanced monitoring and control, real-time updates, adaptive filtering, predictive maintenance, energy efficiency, remote management, and rapid response to abnormalities. The device can be adapted with a dispersal chamber, enhancing consumption experiences such as dispersing flavors, pharmaceuticals, vitamins, micronutrients, prebiotics, and more.

This reusable filtering device provided with one or more housings requiring reassembling of one or more components, with one or more cartridges, comprised with (or without) a customizable multi-staged screening mechanism, such as ion-exchange, activated carbon, catalytic carbon, and Kinetic Degradation Fluxion (KDF): self-contained filtering assembly (i.e.: cartridge) using one or more types of different treatment mediums such as fluids, gases, gels, and air such as environmental and/or polluted air, or solids, salts, gases, fluids, and mixtures thereof, to reduce contaminants such as chloramide, chlorine, fluoride compounds, hormones, pesticides, prescription drugs, freon, microorganisms and Volatile Organic Compounds (VOCs) that may be present in our daily lives such as: benzene, ethylene glycol, formaldehyde, methylene chloride, tetrachloroethylene, toluene, xylene, and 1,3-butadiene within containers such as Refrigerator Cabinets, Beverage Dispensers, Bottles, Buckets, gas masks, hazard suits, Heating and Cooling systems, water heaters, Point of Use filtration systems such as counter top and under the sink connections, etc., with an additional benefit of leverage known smart technologies, and artificial intelligence, and machine learning to collect and report data/information, such as temperature, medium analysis and quality, predict Machine Intelligence and Maintenance. Predictive Analysis to educate the consumer and/or agencies regarding the safety, sanitation, and purification, etc., of media, such as fluids, chemicals, particles, oils, sentiments, gases, solids, salts, and/or air, and combinations thereof, such as environmental and/or polluted atmospheric air, oceans, etc. Another benefit is to incorporate a means to deliver/dispense additives such as vitamins, electrolytes, flavors, proteins, pharmaceuticals, micronutrients, prebiotics, and mixtures thereof, dispersed within a defined means such as in a cartridge, a filter, a chamber, and a reservoir, etc., in such forms as a powder, gel, fluids, solids, wafers, disks, pods, oils, and pellets, etc., intended to enhance taste, increase hydration levels, supplement nutrition, etc.

This device may be reusable and can be made from recycled inorganic materials such as glass, aluminum, polymers, ceramics, and/or organic materials such as bamboo to reduce the carbon footprint while providing a convenient and cost-effective means while controlling quality of the media. This filtering system may provide multi-staged screening mechanisms, such as an ion exchange, reverse osmosis, and activated carbon, etc., filtration that will reduce more contaminants than the standard commercially available consumer water filtering systems, such as residential refrigerators, portable water pitchers, etc., which typically comprise of only activated carbon. This filter device may be installed within the storage chamber of another device or storage unit that is stationary or portable such as a refrigerator, water pitcher, water bottle, beverage station, heating and cooling systems, or attached to, such as a water faucet, tubing, piping, to purify mediums such as the water supply from an external water supply source, gases, airborne pathogens, and pollutants.

Most commercial filtration systems use Total Dissolved Solids (TDS) meters to measure drinkability and safety of water to parts per million (ppm) and cannot measure the levels of lead and arsenic which are harmful at parts per billion (ppb). Multistage filters with smaller pour size, permeability, ion-capturing, etc., would be required.

This filtering system may be comprised of multiple interchangeable filters to allow the consumer to customize their experience by mixing and matching different types of multi-staged screening mechanisms based on their demographic requirements, such as communities whose water sources may exhibit higher levels of contaminants such as metals such as lead, and mercury, etc., inorganic non-metals such as nitrites, nitrates, asbestos and micro-organisms. One or more filter(s) may be designed to be disposable and replaceable. The objective is for the consumer to open the reusable filter housing to insert one or more disposable multistage filters to reduce contaminants in media such as water. In the case of water purifications that may be applicable for other types of media filtration, the filtering device could use one or more of the following multistage screening mechanisms:
Activated Carbon, such as coconut shell carbon or carbon block: Acts like a magnet to reduce contaminants such as pharmaceuticals, herbicides, pesticides, and Volatile Organic Compounds (VOCs).
Catalytic Carbon: Targets the removal of chlorine and chloramines.
Ion-Exchange or Reverse Osmosis: Acts as a screening mechanism to trap and prevent bacteria smaller than 0.01 microns from entering the water supply to help eliminate heavy metals like lead and mercury and remove fluoride.
Absolute Sub-Micron Mechanical Filtration: Captures asbestos and chlorine resistant cysts like cryptosporidium and giardia.
Ultraviolet (UV)-C Filtration: Acts as purification and disinfection mechanism to eliminate harmful micro-organisms, bacteria, and viruses.
Kinetic Degradation Fluxion (KDF): This media primarily consists of copper and zinc such as particulates, mesh, permeable blocks, beads, etc, and is used to reduce the levels of water-soluble heavy metals, including chlorine, iron, and hydrogen sulfide.

The present device will address is spillage of the filtrate. For example, whenever the consumer removes the filtration housing (such as a disposable water filter cartridge from a refrigerator), water always spills out of the housing into the refrigerator's cabinet. The present device may comprise of a membrane or barrier that will mitigate against spillage of the water when the housing is separated from their fittings within the refrigerator.

The filtration housing may maintain a constant flow rate with one or more channels or openings that is positioned to permit ingress and egress of the fluid or gas and one or more channels, such as chambers, conduits, openings, osmosis, etc., to permit egress of the contents media such as fluids, solids, salts, sentiments, chemicals, gases, and air, such as environmental and/or polluted, and mixtures thereof. The filtration device includes a filter with one or more flow channels, such as chambers, conduits, openings, osmosis, etc., for entrance and exiting of medium, and a membrane or barrier composed of materials, such as organic, inorganic, polymer, resins, gelatins, oils, rubber, gas, etc., and/or maybe coated on one or more sides with a substance composed of organic or organics materials by means such as cellulose, paper, and mesh, etc., to reduce backflow and/or permeability which prevents the backflow of the fluids once the filter is removed from its sealed connection. The flow includes one or more channels such as openings, osmosis, etc. for the passage of media, such as with fluids, chemicals, gas, etc., one or more channels such as chambers, conduits, openings, osmosis, etc., for the entering and existing of pre-filtered filtrates, gases, etc. to pass through screening mechanisms of varying: pore sizes, permeability, macrofilters, and microfilters to reduce contaminants.

Each filtering device may be enabled with technology to collect and analyze anonymous data such as the usage behavior of the consumer, contaminant levels, types of contaminants, particulate levels, quality of water or air, temperature etc. Technologies such as Blue-Tooth, Wireless Fidelity (WiFi), Local Area Network (LAN), Wide Area Network (WAN), etc., displayed electronically, such as a LED, or non-electronically, or graphic user interface, communicating with devices such as the Infrared interface of hand-held devices, cellular telephones, satellites, computers such as servers, desktops, laptops and tablets, etc. One intent is to interface with the consumer's filtration device to collect data such as monitoring the levels of the contamination, identifying the types of contaminants, monitoring the consumers level of consumption, et cetera to derive Predictive Analytics which is the use of data, statistical algorithms to identify the likelihood of future outcomes such as safety, sanitation, and purification of the media, based on historical data. The goal is to go beyond knowing what has historically happened to provide an assessment of what may happen in the future with predictive outcomes, such as to health and safety by reporting levels and types of contaminants such as metals, e.g.: lead, and mercury, and inorganic non-metals, e.g.: Nitrites, chloramine, asbestos, etc., and gases, and air pollutants, such as carbon monoxide, nitrogen oxide, sulfur dioxide, etc., organics such as micro-organisms, bacteria, and airborne particulates, pathogens, and pollutants from the media. The information collected can be used to educate the consumer as well as the local and federal government agencies to monitor the health, safety, sanitation, and purification of their local drinking, or emergency water sources to ascertain that it is potable.

The capabilities of the invention may be augmented with technologies such as voice commands, weather data, etc that currently exist in smart devices such as cellular phones, electronic wrist watches, Google Nest thermostats, Amazon's Echo Dot, etc. The invention may interface with other known technologies such as a display on a refrigerator door panel, to enhance the user's education and experience.

The capabilities of the invention may be augmented with an interactive graphical user interface (GUI) displayed on the device itself, or connected to directly, or wirelessly. The data/information collected may include the development of an application to collect, user interaction to provide and receive, and transmit, etc

### EXPLANATION OF THE FIGURES

The discussion of FIGS. 1-9 are to illustrate an example of the basic structure of a reusable filtration system, and any reference numerals referred therein may be assumed or repeated with minor or major alteration in the various alternative embodiments of the present invention. Further discussion of the preferred embodiments of the present invention are herein described with detail specifically noting the many differences from the present invention is possible.

FIG. 1: Example of a Storage cabinet, e.g.: refrigerator containing a filtering device with one housing attached to a pipeline receiving water from an external water source.
Numeral 3: ice machine and container
Numeral 4: water and ice dispenser
Numeral 5: Water faucet
Numeral 6: pipe to ingress water to filter
Numeral 7: pipe to egress water from filter
Numeral 10: water filter device

FIG. 2: Example of water filtering device housing that is inserted into a refrigerator cabinet with one or more components to reassemble.

FIG. 3: Example of a filtering device with a membrane or barrier positioned near or at the inflow and outflow of media to mitigate against spillage.

FIG. 4: Example of filtering device with a the membrane or barrier positioned near or at the inflow and outflow of media to mitigate against spillage. Showing Housing with Cartridge, Filters, and membrane

FIG. 5: Example of filtering device that shows encapsulation of the entire contents within the housing for easy disposal and mitigation against spillage showing a housing with Cartridge, Filters, and membrane.

FIGS. 6-7: Examples of replaceable cartridges with one or more multistage filters inside used within a filtering device.

FIG. 8: Example of media flowing in and out of housing at the apertures that flow directly into the UV-C filtration component, followed by customizable chambers. The last of which containing flavored food pellets.

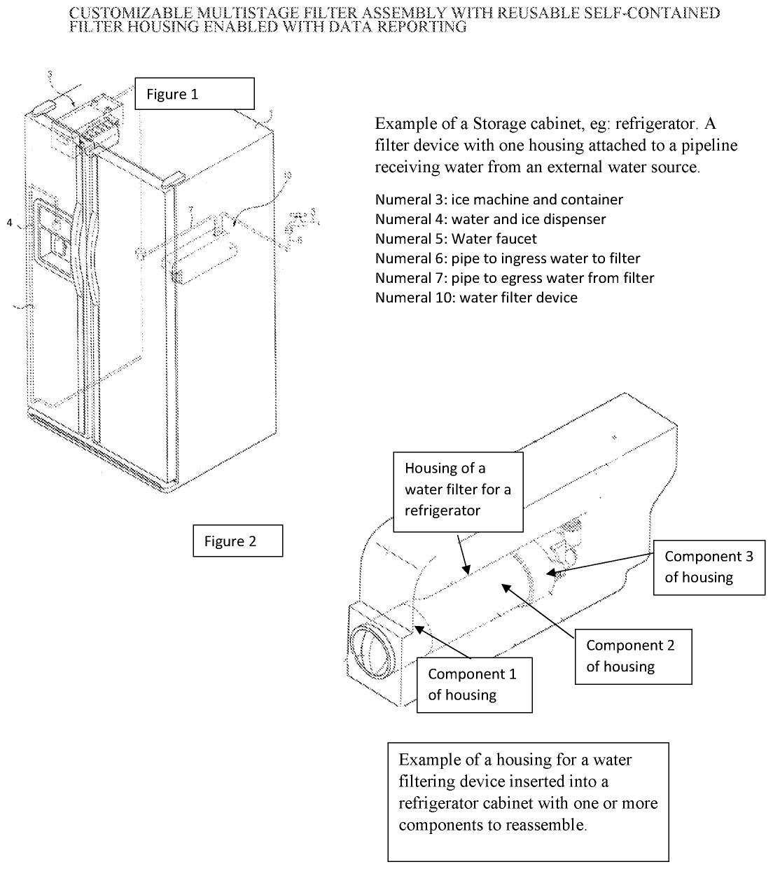

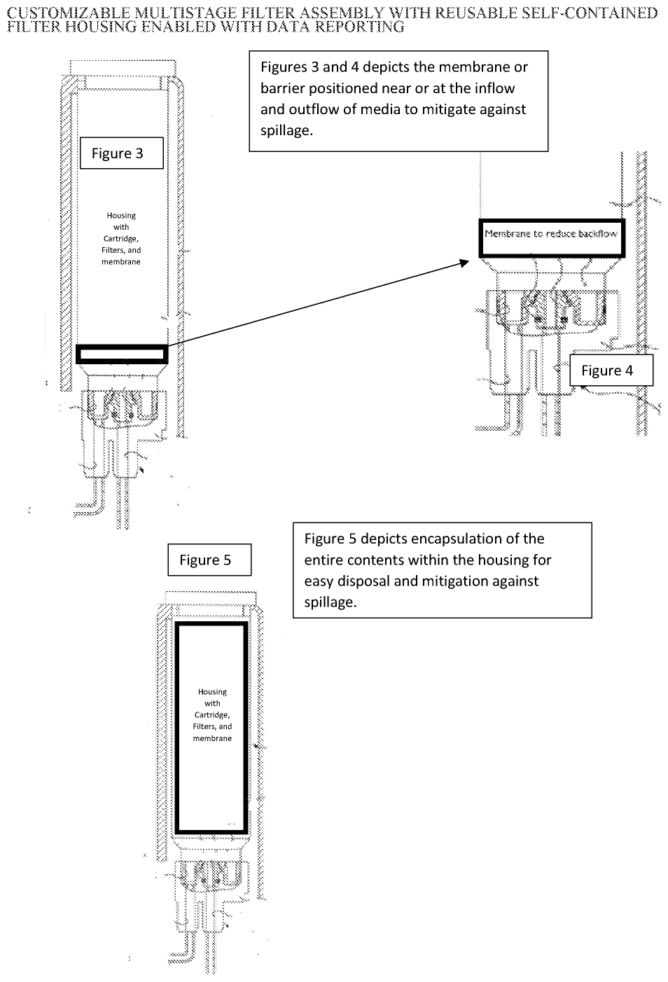

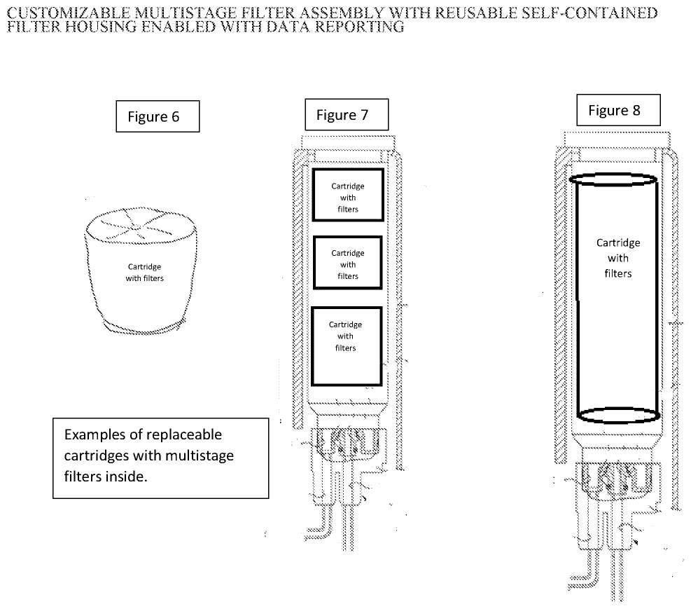

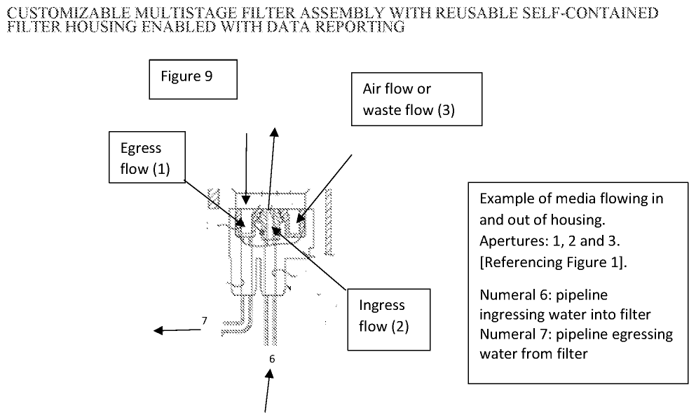

### FILTRATION DEVICE

### Cross Reference to Related Application

The instant application incorporates the entirety of the following publications by reference:
1. US2015/0307366 A1
2. US2012/01002999A1
3. U.S. Pat. No. 10,441,908B2
4. EP2816303A2
5. U.S. Pat. No. 10,105,004 B2

### FIELD OF THE INVENTION

The present invention relates to filtration of media, such as gases, air, solids, salts, oils, gels, fluids, water, and mixtures thereof. The present invention relates to a self-contained, replaceable filter assemblies. The present invention includes the capability of reducing back flow or spillage by the means of a barrier or membrane. The present invention relates to incorporating the capability of analyzing the contents within the filter device to collect, interact, and transmit data to educate the consumer, such as about the health and safety of their water source and consumption. The present invention relates to a reusable housing that could potentially be made from recyclable materials to reduce the carbon footprint and provide additional value to the consumer by being convenient and cost effective. Millions of consumers are using a water filter device that are inserted into refrigerators, and beverage machines, whereas the housing, cartridge and filters are not reusable, and not made from biodegradable or recycled environmentally friendly materials. The end of use for those types of disposable water filters is typically four to six months; the entire filtration device, i.e., the plastic housing, cartridge, and filters contained within are disposed of and dumped into landfills. It may take between 70 to 400 years to degrade these disposable refrigerator water filters.

The present invention relates to delivery of additives to water such as electrolytes, pharmaceuticals, vitamins, nutrients to increase the hydration, add enjoyment of the taste and potentially improve the overall well-being for the consumer. The present filtration invention could exist in multiple forms, such as water refrigeration systems, point of use systems such as faucets, plumbing, etc., heating/cooling systems, air filtration systems, solid filtering systems, portable containers, and beverage dispensers. The present invention is comprised with an optional multi-staged filtration system that can be customizable by the consumer. For example, if the consumer lives in a community or municipality with unsafe levels of heavy metals, such as lead that is seeping from the lead plumbing into their homes, etc, this invention will provide the consumer with the option of using a reusable water filter housing, using one or more different screening mechanisms that are specifically manufactured to reduce the levels of heavy metals such as mercury and lead, as well as the option to select additional multistage filters that specifically targets another contaminant such as non-metals such as chloramide, or that may be evident in their water source; the device will potentially enhance the reduction of contaminants.

Single Point of Use Water filters refers to filtration devices that exist in refrigerators, on counter tops, or under the sink, etc., connected to a water pipe. The present device is a reusable housing (that could be made from recyclable organic and non-organic materials, such as glass, aluminum, polymers, plastics, and bamboo) and replaceable inner filters, potentially made from recyclable materials, will provide a cost effective, environmentally friendly, green alternative against the commercially available one-piece disposable plastic refrigerator cartridges housing that are cost prohibit, and increase the carbon footprint and pollution after four to six months. Consumers with better water filtration system options tend to purchase less disposable plastics water bottles that also contribute to the pollution in the landfills and oceans.

Single Point of Use Water filters that reside in residential refrigerators are typically comprised of one type of screening mechanisms, that is, conventional activated carbon, which may not reduce a myriad of contaminants, such as lead, existing within their water source. For example, if the consumer lives in a community with known unsafe levels of heavy metals, such as lead, seeping out of lead pipes into their drinking water, this invention will provide the consumer with the option to select the appropriate filter screening mechanism such as coconut shell carbon and carbon block, that are specifically manufactured to reduce the levels of heavy metals such as mercury and lead, as well as select the option to add another filter screening mechanism that specifically targets non-metals such as chloramide, and yet another filter screening mechanism, such as Kinetic Degradation Fluxion (KDF) to broaden the capabilities of the filtration system to the reduce the amount of contaminants in the drinking water. Ultraviolet (UV)-C Filtration capability is intended for every filtration device who's goal is to reduce harmful bacterias, viruses, and micro-organism that are connected to a power source, such as solar panels, electricity, electromagnetic radiation, etc.

The desalination of water is commonly achieved using a combination of filtration and reverse osmosis techniques, wherein salt and other impurities are eliminated from seawater or brackish water. By augmenting the filtration device with a chemical process, a superior filtration technology can be achieved.

The chemical process involves a sequence of pre-treatment, chemical mixing and heating, filtration, and post-treatment stages.

The pre-treatment stage encompasses passing water through filters to eliminate significant particles and impurities, like sand and sediment. This is essential to shield downstream systems and improve the overall efficiency of the device. Subsequently, the water is combined with specific chemicals that are capable of generating heat through their reaction, such as magnesium oxide and hydrochloric acid. The resulting exothermic reaction releases sufficient heat, which is then utilized to boil the saltwater and separate the water from the salt. The water vapor generated from the boiling process is extracted and collected as distilled water.

After the distillation stage, the water undergoes another filtration stage to eliminate any residual impurities, like minerals or other dissolved substances. This additional filtration process ensures that the water is safe for human consumption. The application of chemical mixing and heat generation processes in the desalination filtration device offers an innovative and effective solution for providing fresh water in areas where clean water accessibility is limited.

### BACKGROUND OF THE INVENTION

Clean and safe water and air is a fundamental human need that is essential to our well-being, communities, and economies. Humans require at least 20 to 50 liters of clean, safe water a day for hydration, cooking, and hygiene. Polluted air and water is not only unclean; it's fatal to our existence. Every year over two million people from water-poor communities die of diarrheal from diseases such as cholera. Tens of millions of others are seriously sickened by a myriad of preventable water-related ailments. Water-poor communities are typically economically poor as well, there are residents trapped in an ongoing cycle of poverty. Our economy depends on clean water. Education, health care facilities, restaurants, farming, tourism, manufacturing, recreation, energy production, and other economic sectors need clean water to operate and develop successfully.

Education suffers when sick children are unable to attend their classes in school due to water related ailments. Economic opportunities are typically lost to the impacts of rampant illness and the time-consuming processes of acquiring water where it is not readily available. Children and women bear the brunt of these burdens.

Sanitation and the removal of contaminants are equally important, and complementary uses of water. A lack of a proper filtration screening mechanisms not only contributes to disease, but it can also deprive people of their basic human dignity and existence.

Consumers are adding flavors to their tapped or bottled drinking water daily because they are not satisfied with the taste. Aside from minerals derived directly from natural water sources, which may lead to unsafe sodium levels, over prolong use, drinking water offers no nutritional value.

### SUMMARY OF THE INVENTION AND BENEFITS

This invention relates to filtration of liquids, solids, salts, chemicals, sentiments, particulates, gases, air, and mixtures thereof. The subject matter disclosed herein relates to a filtering system that improves upon or overcomes one or more of the shortcomings of existing filtrations devices or systems. Specifically, the present invention relates to a reusable filter device assembly potentially made from recyclable materials for the housing, and disposable/replaceable multistage filter assemblies within one or more cartridges; augmented with the potential capabilities to collect and report anonymous data relating to indicators such as levels and types of contaminants in communities and municipalities, consumption, pattern of usage behaviors, potability, etc.
1.
   a) This invention will be a reusable sanitary, purification filtration system made from recycled materials to reduce the amount of environmental waste.
   b) This invention will be a reusable housing to provide a convenient and cost-effective means while controlling quality of the media, such as water.
   c) This invention if implemented within refrigerators and similar containers may reduce environmental waste by replacing their one-piece disposable water filter cartridge system
   d) This invention will use one or more screening mechanisms to filter contaminants.
   e) This invention will permit the customization of the filtration system by providing one or more screening mechanisms within a housing.
   f) This invention will provide the possibility of customizing the filtration system by providing one or more filters screening mechanisms such as ion exchange, activate or catalytic carbon, KDF, etc., within a housing.
   g) This invention will use one of more screening filters that may vary in size and orientation.
   h) This invention will provide for a filter system that allows for modular replacement of the medium such as salts, gels, solids, fluids, gas, etc.
   i) This invention will provide a membrane barrier to reduce backflow and spillage of a fluid, solid, or gas medium.
   j) The invention is designed to collect and report data regarding the medium.
      i. If enabled with such technologies as WiFi, Bluetooth, and LAN/WAN, the device will transmit anonymous consumer information to report predictive analytical data.
      ii. The data collected can be used to educate the consumer as well as local and federal government agencies to monitor the safety of their local drinking water.
   k) This invention's housing may comprise of two or more components separated or connected vertically or horizontal or a combination thereof.
   l) The housing is made to be reused with one or more components may include an upper body and a lower body that can be fastened and unfastened to one another through various means, such as snapped on, screwed on, twisted on, bayonet fittings, tab fastener, clamps, switch locked, inserted, etc. to allow for access to the interior contents including the media.
   m) The filter device is operable wherein said filter cartridge is at an angle of 0 to 360 degrees from a horizontal or vertical position.

Commercially, the filtration device may be used in connection with: inner and rural cities, communities, institutions, municipalities, remote and impoverished regions, tourisms, entertainment, outdoor activities, recreational sports, food and beverage, military and healthcare.

While the invention is described in conjunction with specific embodiments, many alternatives, modifications, permutations and variations arm possible.

Accordingly, it is intended that the invention embraces all such alternatives, modifications, permutations and variations as falling within the scope of the claims below.

1. A filtering device comprising:
a housing assembly that may be made from reusable materials as well as reusable and may be sealed with one or more components that can be fastened and unfastened to one another through various means such as snapped on, screwed on, twisted on, bayonet fittings, tab fastener, clamps, switched locked and inserted to allow for access to the interior contents including the media with one or more openings to permit ingress and egress passage of the media, such as fluid, solids, and gas, and any combination thereof into chamber(s);
a filtering cartridge that may be tightly sealed within one or more housings, the filter cartridge having one or more side(s) wall with shape selected from cylindrical, rectangular, square, and variations thereof, composed of solid materials of varying thickness and/or composition.

2. One or more membrane or barriers, if required, coated with one or more substances, if required, to mitigate spillage of media; one or more permeable layers, one or more porous outlets, one or more filter cartridges, and one or more macro-filters, one or more micro-filters; one or more membranes or barriers to mitigate spillage of the contents, dispensing one or more additives, that may be enabled with a means for data collection within the housing(s) in shape; wherein the media travels into the housing through one or more permeable layers and through the inline filters of the filter cartridge; when enabled with the appropriate technologies will be capable of analyzing the data of the media.

3. The filter device of claim 1 wherein a multistage filtration system that use one or more filter screening mechanisms passing a media through a first communication of said housing, then through said filter cartridges to remove contaminants such as sediment, particulates, chemicals, oils, salts, and metals, non-metals, and organisms that may be present in said media.

4. The filter device of claim 1 wherein said filter cartridge includes disbursement of additives such as in the forms of powders, gels, pellets, and/or pods to disperse medications, flavors, electrolytes, or nutrients and mixtures thereof to enhance taste, increase hydration, nutritional supplementation, and compliance upon delivery of said additives as in the case of filtered water;
may include a separate component that is not directly connected to the filtration device to disperse additives internal (such as, within a cabinet door) or external (such as, outside a cabinet door) to the refrigeration cabinet.

5. The filter device of claim 1 further comprising of one or more components of the housing to include an upper body and a lower body that can be fastened and unfastened to one another through various means, selected from, snapped on, screwed on, twisted on, bayonet fittings, tab fasteners, clamps, switch locked, clicked and inserted, combinations thereof to allow for access to the contents of the housing(s) or may be attached to a storage container selected from a refrigerator cabinet, beverage dispenser, water bottle, heating and cooling, or gas masks by twisted on, screwed on, snapped on, clicked on, switch locked, or inserted and combinations thereof.

6. The filter device of claim 1 may comprise a membrane or barrier composed of materials, selected from organic, inorganic, polymer, resins, gelatins, oils, rubber, and gas, and combinations thereof, and/or coated on one or more sides with a substance to reduce backflow and permeability.

7. The filter device of claim 1 may comprise of screening mechanisms that are customizable utilizing one or more of screening mechanisms to target and reduce specific contaminants in said media with varying pore sizes and permeability or combinations thereof, to reduce contaminants.

8. The filter device of claim 1, if enabled, may be capable of analyzing the contents of the media to potentially provide historical statistical data useful to predict future outcomes of the health, safety, purification, and sanitation.

9. The filter device of claim 1 may collect or communicate the media from an internal/external source such as a pipe or tubing, or portable by means of pitcher or bottle, or apparel, or open source selected from a bucket or pond, and atmospheric air, etc., that communicates with the filter housing, cartridge and any contents therein.

10. A method for filtering comprising: the filter device of any one of the proceeding claims that may be secured to a container such as a bottle, cabinet, dispenser, or apparel to filter media selected from fluids, gases, chemicals, salts, particulates, oils, sentiments, and solids or mixtures thereof, received from direct or indirect sources, portable containers, apparel, and open sources such as buckets, lakes, reservoirs, atmosphere air or collected rainwater.
